(19) United States
(12) Patent Application Publication
(10) Pub. No.: US 2003/0158764 A1
(43) Pub. Date: Aug. 21, 2003

(54) Development evaluation system and method

(76) Inventor: Yi Ming Liao, Taipei (TW)

Correspondence Address: JACOBSON HOLMAN PLLC, 400 SEVENTH STREET N.W., SUITE 600, WASHINGTON, DC, 20004, US

(21) Appl. No.: 10/075,265

(22) Filed: Feb. 15, 2002

(51) Int. Cl. G06F 17/60

(52) U.S. Cl. 705/7

(57) ABSTRACT

A method to evaluate the value of applied development software. The main objective of the disclosed invention is to improve efficiency of long-term investments in developing various kinds of software. The development evaluation method includes at least the following steps: establishing applied development software, establishing a development evaluation system, and evaluating development efficiency . The system and method is capable of providing effective evaluation data to improve the present circumstances of unilaterally and passively accepting requests for developing software.

### FIELD OF THE INVENTION

The invention is an economic evaluation system and method, and in particular, a system and method that evaluates the economic efficiency of enterprise investments.

### RELATED ART

In a keen competitive environment, an enterprise needs to invest funds in software research and development. Appropriate investment can bring essential benefits to an enterprise and decrease time wasting in recruiting employees on meaningless assignments. This kind of decision-making and software evaluation is of great concern for enterprises. However, under what kind of considerations can generate more appropriate standards and bases become pre-examinations of long-term profits and losses in the future. Developing software costs a lot of money and there may be no funds left after the software has been developed. So, an enterprise must be cautious in making strategic decisions beforehand.

When receiving a request to develop software from a user, an enterprise adapts unilateral descriptions that user. Without any historical data to follow, most enterprises merely accept requests passively. After a period of time when software has been developed and operated, the enterprise may find that operation of the developed program is far below expectations. Therefore, developed software does not heighten efficiency but wastes many resources. Thus, it is to establish a system that is capable of recording practical operations of software and generating efficient evaluations. MIS engineers still cannot discuss the value of software with users based on any related data where there is any request of developing new software, if operations of developed software have not been well recorded.

Therefore, it is necessary to establish a simple and convenient development evaluation system to resolve such problems. For example, those major factors and rules of thumb related to an enterprise's investment plans, how to evaluate the investment plans with risks and uncertain factors, and the advantages and the disadvantages analysis of all fields and ranges of acceptable subjects.

### SUMMARY OF THE INVENTION

The disclosed invention aims at resolving the above-mentioned problems by proposing a practical development evaluation system and method. The major objective of the development evaluation system is to improve the efficiency of longterm investments in developing various kinds of software.

The disclosed development evaluation method includes at least following steps:

Firstly, establish applied development software to support departmental operations. Then, establish a development evaluation system to analyze the economic efficiency of the applied development software. The established development evaluation system further consists of an input recognition module, a process recording module, a resource statistics module, an evaluation and comparison module, and a central control module, for confirming the user's ID, recording and assessing software operation conditions. It further evaluates the economic efficiency of the applied development software through recorded operating conditions and integrated statistics.

The disclosed development evaluation system includes at least the following:

an input recognition module, which is utilized for confirming the user ID entering the applied development software; a process recording module, which is utilized for recording a user's operating condition; a resource statistic module, which is utilized for assessing operating conditions and integrated statistics output results; an evaluation and comparison module, which is utilized for comparing the differences between operating conditions and predicted requirements; and a central control module, which is utilized for connecting and monitoring the operation of the respective modules in the development evaluation system.

The evaluation method disclosed by the invention includes at least following steps:

Obtaining predicted requirements and operating conditions; comparing the differences between predicted requirements and operating conditions; and calculating the economic efficiency through an evaluation function.

The feasibility and practicality of the invention will be elaborated by means of an embodiment depicted in the following.

### BRIEF DESCRIPTION OF THE FIGURES

FIG. 1 is a systematic structure of the development evaluation system and method of the invention;

FIG. 2 is an operational flowchart of the development evaluation system of the invention; and

FIG. 3 is an evaluation flowchart of the development evaluation system of the invention.

### DETAIL DESCRIPTION OF THE INVENTION

The disclosed invention proposes a development evaluation system and method to evaluate the economic efficiency of an enterprise's investments. The system develops an interactive software evaluation system, which improves the present situations of unilaterally and passively accepting proposed requests for program development, and lacking communication foundations in maintaining a program through operating records in respective departments, by analyzing actual requirements of the software and comparing the records with predicted requirements.

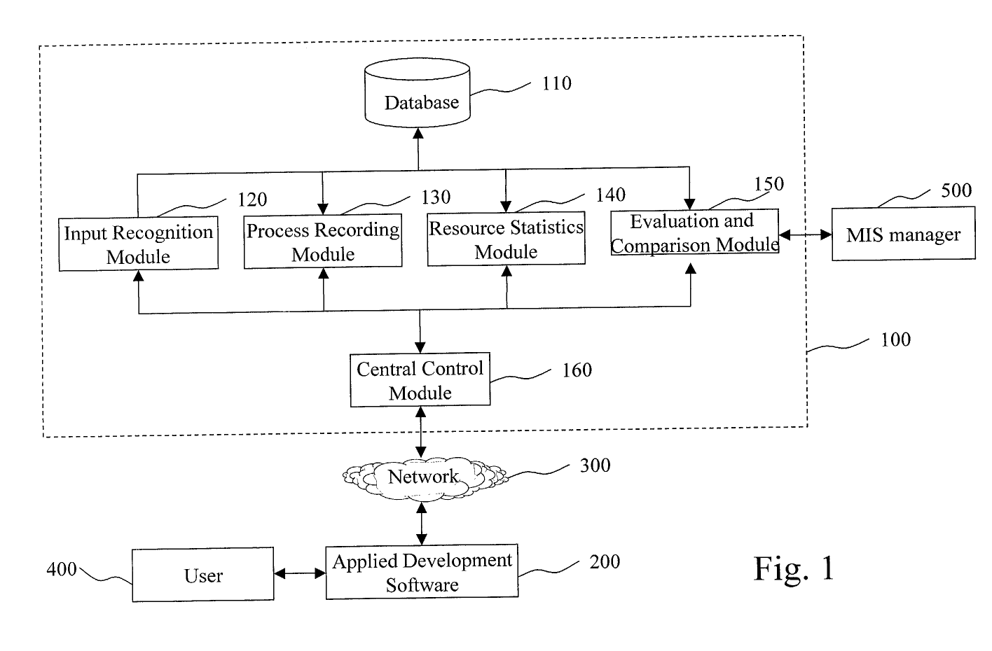

As shown in FIG. 1, the systematic structure of the disclosed development evaluation system is described as follows:

The invention discloses a development evaluation system 100, which is utilized for evaluating the development value of software 200 . When a user 400 enters the applied development software 200, a confirmation message is generated to ask a user to input the necessary information, such as the department code and personal code for ID confirmation. If the user is recognized, s/he is allowed to operate the software. In the mean time, the software operation process and the status of the user 400 is automatically recorded in a table and sent to the database 110 for storage. After a period of time, the server will re-count this data and send out the statistical data to MIS people via e-mail.

The development evaluation system 100 includes the following five modules: (1) the input recognition module 120; (2) the process recording module; (3) the resource statistics module; (4) the evaluation and comparison module; and (5) the central control module. The respective modules are described as follows:

(1) The input recognition module 120 is utilized for confirming the identification (ID) and department code of a user 400 who wants to enter the applied development software 200.

(2) The process recording module 130 is utilized for recording the ID of the user 400 who is operating the applied development software 200.

(3) The resource statistic module 140 is utilized for counting the resource records of the ID, the department code, and software operating time of the user 400. These records are stored in the database 110 and are respectively filled in tables according to the counted statistics resource application amount of different software and departments.

(4) The evaluation and comparison module 150evaluates the economic efficiency of statistical operating records of users in advance. It further compares the statistic results with the variation demand list previously proposed by the user to check if the user's operating conditions differ from the applicant's prediction . Moreover, it chooses an appropriate evaluation method to analyze the statistical results and use these records as parameters to input an evaluation function, or input other methods established in the database. The system obtains a referential evaluation result, which is displayed as a data table after being compared and evaluated, either to be printed out via the system 100 or automatically sent by e-mail to MIS engineers 500.

(5) The central control module 160 receives and transits messages among all modules of the system 100 to monitor their respective operations. The central control module 160 is the message control center of the development evaluation system 100 connecting to the applied development software 200 via a network 300, or capturing required data records of the development evaluation system through the server.

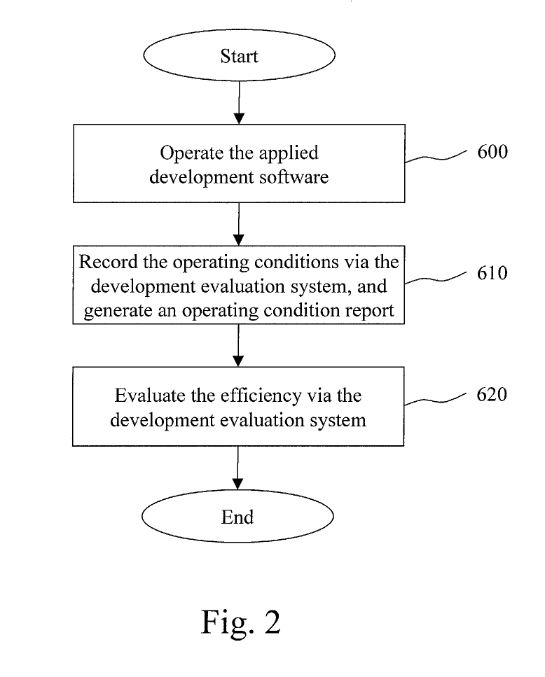

FIG. 2 is an operational flowchart of the development evaluation system of the invention. The main procedure of the invention is described as follows:

When the user 400 enters the applied development software 200, the system displays a login screen requesting the user to log in, and prompts the user 400 to enter authentication data such as ID and department code . After confirming the user's ID, the applied development software 200 is accessible to the user 400 (step 600). While the user 400 operates the applied development software 200 , the development evaluation system 100 automatically records the user's operating time and the resource application amount (step 610) until the user 400 logs out from the system. The MIS manager is capable of checking the records or processing evaluations at regular intervals. The development evaluation system 100 automatically and routinely outputs recorded operating conditions and utilizes statistical results to evaluate the economic efficiency (step 620). The evaluation results are printed out in report tables, or automatically sent via e-mail to the MIS manager.

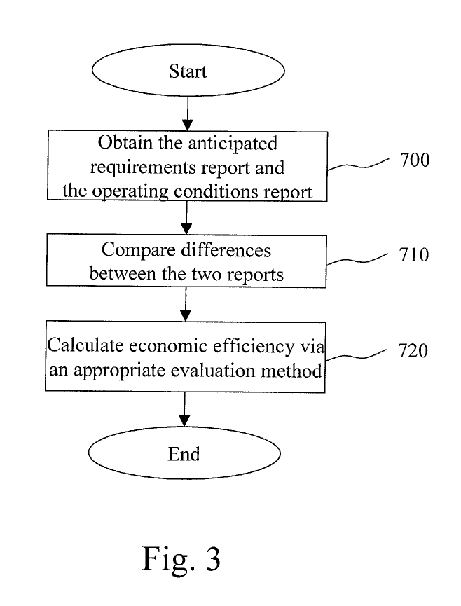

FIG. 3 is an evaluation flowchart of the development evaluation system of the invention. The detailed procedure of the development evaluation system is described as follows:

Firstly, the system reads integrated statistical data from both the original predicted requirements proposed by the user and the user's practical operating conditions (step 700). The development evaluation system 100 begins by comparing predicted requirements and the user's practical operating conditions (step 710), and outputs the variation report, which is utilized for calculating economic efficiency (step 720). The system then chooses an appropriate evaluation method to analyze the statistical data. The system uses this statistical data as a parameter and inputs an evaluation function. It can utilize the parameters of the operation times, the operating time, or the resource application amount to evaluate the economic efficiency of the applied development software. The following formula (1):

Economic efficiency=A (operation times)+B (operating time)+C (resource application amount)+D (1)

can be simplified as the form of f(x, z)=Ax+By+Cz+D. Wherein the f(x, y, z) is a dependent variable and x, y, z are independent variables; f(x, y, z), the economic efficiency, varies according to variations of x, y, z. The function adapts “operation times”, “operating time”, and “resource application amount” as the indices for evaluating economic efficiency. Among those indices, there are A, B, C, which are the coefficients of x, y, z, and which respectively represent the slope of “operation times”, “operating time”, and “resource application amount” to “economic efficiency”. In other words, the slope represents different levels of influences of “operation times”, “operating time”, and “resource application amount” to “economic efficiency”, whereas D represents the residuals of the whole function, which is amended deviation for the terminal of f(x, y, z), among which A, B, C, D can be obtained in existence or through the multivariate analysis of virtual data. Moreover, to be continuously corrected with the gathered statistic results afterwards, it displays the closest evaluation and prediction with the practical conditions.

The operations of the respective software and operation requirements of users are different. Therefore, it is necessary to obtain a preferred referential evaluation utilizing the aforementioned results of other evaluation methods established in the database to evaluate, through the development evaluating system, possible economic efficiency from consuming these resources. It also improves the evaluation precision of the development evaluation system 100 while comparing the calculated results of every time with the practical conclusion for correcting the feedback coefficients of evaluation function or other parameters.

An invention is disclosed herein. These and other variations, which will be understood by those skilled in the art, are within the intended scope of the invention as claimed below. As previously stated, detailed embodiments of the invention are disclosed herein, however, it is to be understood that the disclosed embodiments are merely exemplary of the invention that may be embodied in various forms.

What is claimed is:

1. A development evaluation method applies an evaluation of applied development software for an enterprise to evaluate economic efficiency of the applied development software, which comprises the steps of:
establishing the applied development software for supporting operations of at least one department;
establishing a development evaluation system for analyzing economic efficiency of the applied development software, and confirming, recording, and counting a user's operating condition of the applied development software, then using the user's operating condition to compare and evaluate values of the applied development software and output statistic reports.

2. The development evaluation system of claim 1, the step of for analyzing economic efficiency of the applied development software, and confirming, recording, and counting a user's operating condition of the applied development software, then using the user's operating condition to compare and evaluate values of the applied development software and output statistic reports, which further comprises the steps of:
establishing an input recognition module for confirming the ID and department of a user operating the applied development software ;
establishing a process recording module for recording the user's operating condition of the applied development software;
establishing a resource statistics module for counting the operating conditions of the process recording module, and categorizing the output statistic results;
establishing an evaluation comparison module for comparing and evaluating the integrated statistic results of the resource statistics module and
establishing a central control module for communicating and monitoring the development evaluation system and operations of respective modules of the system;

3. The development evaluation system of claim 1, wherein the applied development software is assistant software required on work by users.

4. The development evaluation method of claim 1, wherein operating the applied development software, which further comprises the steps of:
confirming the user's ID via the input recognition module; and
permitting to execute the applied development software.

5. The development evaluation system of claim 4, wherein the input recognition module can be operated for confirmation via the network connection.

6. A development evaluation system applies for managing a developed applied development software to record and evaluate the operating conditions of the applied development software, which comprises:
an input recognition module, which confirms ID and department code of a user, who is operating the applied development software;
a process recording module, which records the user's operating condition of the applied development software;
a resource statistics module, which counts the operating conditions recorded by the process recording module and integrating statistic outputs;
an evaluation and comparison module, which compares the differences between a file integrated by the resource statistics module and an predicted requirement report proposed by an applicant of the applied development software, and evaluates an economic efficiency of the developed software; and
a central control module, which communicates and monitors the development evaluation system and operations of respective modules of the system.

7. The development evaluation system of claim 6, wherein the input recognition module is able to recognize, via the network, ID and department of the user, who is entering the applied development software.

8. The development evaluation system of claim 6, wherein the process recording module is able to record the user's operating condition via the network.

9. The development evaluation system of claim 6, wherein the resource statistics module is able to integrate and output the statistic data recorded by the process recording module via the network.

10. The development evaluation system of claim 6, wherein the predicted requirement report is a variation demand proposed by the applicant before establishing the applied development software.

11. A development evaluation method aims at evaluating the efficiency of developed software as the base of decision-makings assistance, which comprises the steps of:
obtaining an predicted requirement report and an operating conditions report;
comparing the differences between predicted requirement report and the operating conditions report; and
calculating a economic efficiency via an evaluation function.

12. The development evaluation method of claim 11, wherein after analyzing the economic efficiency, it further includes an outputted evaluation report.

13. The development evaluation method of claim 11, wherein the evaluation function is the algorithm for calculating the economic efficiency.

14. The development evaluation method of claim 11, wherein the evaluation function further includes an evaluation foundation for feedback and correction.
